(19) United States
(12) Patent Application Publication
(10) Pub. No.: US 2025/0075532 A1
(43) Pub. Date: Mar. 6, 2025

(54) LATCH APPARATUS, SHEET CONVEYING APPARATUS, AND IMAGE FORMING APPARATUS

(71) Applicant: CANON KABUSHIKI KAISHA, Tokyo (JP)

(72) Inventor: SHINYA KITAGO, Chiba (JP)

(21) Appl. No.: 18/781,075

(22) Filed: Jul. 23, 2024

(30) Foreign Application Priority Data
Aug. 28, 2023 (JP) 2023-138093

(51) Int. Cl. E05B 57/00; B65H 5/06

(52) U.S. Cl. CPC E05B 57/00; B65H 5/062; B65H 2402/441; B65H 2801/06

(57) ABSTRACT

A latch apparatus configured to latch an opening and closing door that is opened and closed with respect to a housing to the housing includes: a latch to be provided to the opening and closing door; a handle, which is to be provided to the opening and closing door and is configured to operate the latch; and an engaged member, which is to be provided to the housing and is engageable with the latch. When the opening and closing door is closed, the latch is engaged with the engaged member. When the latch is operated by the handle in a state in which the opening and closing door is closed, the latch is disengageable from the engaged member. A position of the engaged member is adjustable in an engagement direction in which the latch is brought into engagement with the engaged member.

### BACKGROUND OF THE DISCLOSURE

### Field of the Disclosure

The present disclosure relates to a latch apparatus that latches an opening and closing door, a sheet conveying apparatus, and an image forming apparatus.

### Description of the Related Art

An image forming apparatus including an opening and closing door has a configuration of allowing access to an inside of the apparatus when the opening and closing door is in an open state and engaging a latch provided to the opening and closing door with an engaged member to lock the opening and closing door to maintain the opening and closing door in a closed state. In Japanese Patent Application Laid-Open No. 2017-161757, there is disclosed an image forming apparatus including an opening and closing door that is rotatable about a rotation shaft. A metal frame is provided to the opening and closing door. The metal frame is suspended from the opening and closing door through intermediation of a latch shaft supporting a rotation latch and a rotation shaft for the opening and closing door. Urging members that urge a removable unit that is removable from an image forming apparatus main body are provided to the metal frame. According to the Japanese Patent Application Laid-Open No. 2017-161757, strength of the opening and closing door can be improved while operability of the opening and closing door is maintained.

Meanwhile, for example, in a case of a large opening and closing door provided to a large image forming apparatus such as a B3-size printer or a high-speed printer for continuous slip, relative positions of a latch and an engaged member may be shifted by, for example, warping caused by a self-weight of the opening and closing door or a dimensional variation of a component. With a shift in the relative positions of the latch and the engaged member, the latch may be unsatisfactorily engaged or fail to be engaged with the engaged member and thus result in a nonengaged state when the opening and closing door is closed.

Further, in a case in which one roller of a roller pair of a conveying apparatus, a fixing apparatus or the like is provided to a housing of the image forming apparatus and the other roller of the roller pair is provided to the opening and closing door, the roller provided to the opening and closing door is pressed against the roller provided to the housing when the opening and closing door is closed. When a sheet with high stiffness such as a sheet of thick paper is conveyed between the rollers of the roller pair, which are pressed against each other as described above, a reaction force generated when the sheet is interposed between the rollers of the roller pair acts on the opening and closing door. Thus, the latch and the engaged member receive a force in a direction of opening the opening and closing door, that is, releasing the latch. This force may warp the opening and closing door. As a result, the latch cannot be successfully engaged with the engaged member and may result in a nonengaged state.

In order to prevent the nonengagement of the latch with the engaged member, it is conceivable to increase the amount of contact between the latch and the engaged member. However, when the amount of contact is increased, the latch and a latch releasing mechanism may be increased in size, resulting in an increase in size of the image forming apparatus as a whole. Further, it is also conceivable to adjust a position of the opening and closing door through position adjustment of hinges for the opening and closing door so as to increase the amount of contact between the latch and the engaged member. However, the opening and closing door having a large size is heavy. Thus, a plurality of workers are required to adjust the positions of the hinges for the opening and closing door or an apparatus for lifting up the opening and closing door is used. As a result, workability may be lowered.

### SUMMARY OF THE DISCLOSURE

According to an aspect of the present disclosure, a latch apparatus configured to latch an opening and closing door that is opened and closed with respect to a housing to the housing includes: a latch to be provided to the opening and closing door; a handle, which is to be provided to the opening and closing door and is configured to operate the latch; and an engaged member, which is to be provided to the housing and is engageable with the latch, wherein, when the opening and closing door is closed, the latch is engaged with the engaged member, wherein, when the latch is operated by the handle in a state in which the opening and closing door is closed, the latch is disengageable from the engaged member, and wherein a position of the engaged member is adjustable in an engagement direction in which the latch is brought into engagement with the engaged member.

According to another aspect of the present disclosure, a sheet conveying apparatus includes: a conveying portion configured to convey a sheet; a housing; an opening and closing door configured to be opened and closed with respect to the housing; a latch provided to the opening and closing door; a handle provided to the opening and closing door and configured to operate the latch; and an engaged member, which is provided to the housing and is engageable with the latch, wherein, when the opening and closing door is closed, the latch is engaged with the engaged member, wherein, when the latch is operated by the handle in a state in which the opening and closing door is closed, the latch is disengageable from the engaged member, and wherein a position of the engaged member is adjustable in an engagement direction in which the latch is brought into engagement with the engaged member.

According to another aspect of the present disclosure, an image forming apparatus includes the sheet conveying apparatus and an image forming portion configured to form an image on a sheet conveyed from the sheet conveying apparatus.

Further features of the present disclosure will become apparent from the following description of exemplary embodiments with reference to the attached drawings.

### BRIEF DESCRIPTION OF THE DRAWINGS

FIG. 1 is a sectional view of an image forming apparatus.

FIG. 2 is a schematic perspective view of a feeding module.

FIG. 3 is a schematic perspective view of the feeding module with an upper door unit open.

FIG. 4 is a schematic perspective view of a handle, latches, and other components in the vicinity thereof.

FIG. 5A and FIG. 5B are schematic sectional views of a latch releasing mechanism of the handle and other components in the vicinity thereof.

FIG. 6A and FIG. 6B are schematic side sectional views of the upper door unit provided with an elastic member for operation assistance.

FIG. 7 is a graph for showing an example of operational force curves when the upper door unit is opened and closed.

FIG. 8 is a schematic perspective view of the latch, an engaged member, and other components in the vicinity thereof.

FIG. 9 is a schematic perspective view of a support member, the engaged member, and other components in the vicinity thereof.

FIG. 10A and FIG. 10B are schematic views for illustrating the engaged member before position adjustment.

FIG. 11A and FIG. 11B are schematic views for illustrating the support member after a stopper is removed from the support member in a state illustrated in FIG. 10A and FIG. 10B.

FIG. 12A and FIG. 12B are schematic views for illustrating the engaged member being in abutment against the latch after the engaged member is moved.

### DESCRIPTION OF THE EMBODIMENTS

Hereinafter, the embodiments of the present disclosure will be described with reference to the accompanying drawings. However, the present disclosure is not limited to the following embodiments.

### (Image Forming Apparatus)

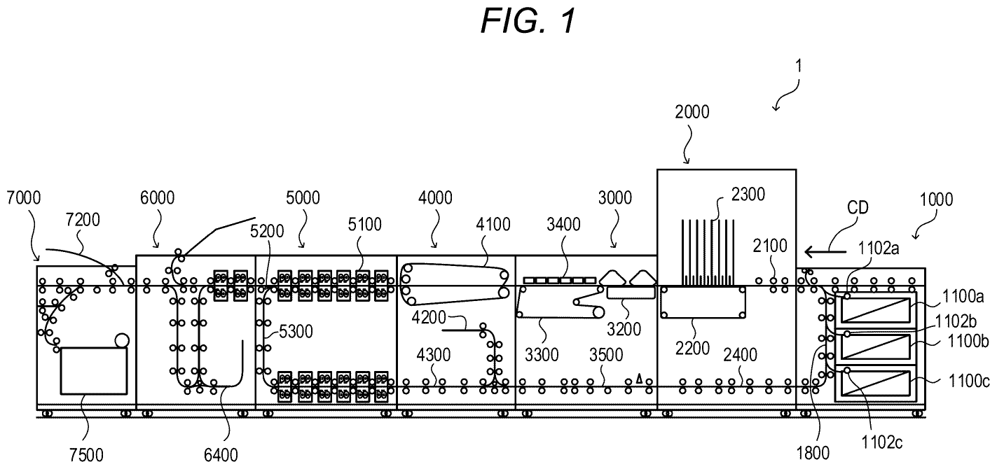

Now, an image forming apparatus 1 according to the embodiment is described with reference to FIG. 1. FIG. 1 is a sectional view of the image forming apparatus 1. The image forming apparatus 1 is a sheet-fed type and uses two components corresponding to a reaction liquid and ink to form an ink image (image) on a sheet. The image forming apparatus 1 includes a feeding module (sheet conveying apparatus) 1000, a print module 2000, a drying module 3000, a fixing module 4000, a cooling module 5000, a reversing module 6000, and a discharge stacking module 7000. A sheet fed from the feeding module 1000 is conveyed along a conveying path, is processed in the modules described above, and is discharged to the discharge stacking module 7000.

### (Feeding Module)

The feeding module 1000 includes three storages (sheet storages) 1100a, 1100b, and 1100c, each storing a plurality of sheets. Three feeding portions 1102a, 1102b, and 1102c are arranged so as to be opposed to the sheets stored in the three storages 1100a, 1100b, and 1100c, respectively. The sheets stored in the storages 1100a, 1100b, and 1100c are separated one by one by the feeding portions 1102a, 1102b, and 1102c serving as conveying portions and are conveyed to the print module 2000 via a conveying path inside the feeding module 1000. The number of storages is not limited to three, and may be one, two, four or more. Another feeding module is coupled to a right side of the feeding module 1000 of FIG. 1 to achieve so-called “multi-coupling”, and then a further set of a plurality of feeding portions can be provided.

### (Print Module)

The print module 2000 includes a before-image-formation registration correcting portion 2100, a print belt unit 2200, and a recording portion (image forming portion) 2300. A skew and a position of the sheet conveyed from the feeding module 1000 are corrected by the before-image-formation registration correcting portion 2100, and then the sheet is conveyed to the print belt unit 2200. The recording portion 2300 is arranged at such a position as to be opposed to the print belt unit 2200 across the conveying path. The recording portion 2300 is an image forming portion that performs a recording process (printing) using recording heads from above on the conveyed sheet in a conveyance direction CD so as to form an image on the sheet. When the sheet is attracted and conveyed by the print belt unit 2200, a clearance between the sheet and the recording heads is ensured.

A plurality of recording heads are arranged in the conveyance direction CD. In the embodiment, the recording heads include a total of five line-type recording heads corresponding to four colors, that is, yellow (Y), magenta (M), cyan (C), and black (Bk), and a reaction liquid. The number of colors and the number of recording heads are not limited to five. As an ink jet system, various systems including, for example, a system using heating elements, a system using piezo elements, a system using electrostatic elements, and a system using micro electro mechanical system (MEMS) elements can be employed. An ink of each of the colors is supplied from an ink tank to the recording head via an ink tube. The sheet printed by the recording portion 2300 is conveyed by the print belt unit 2200 to an inline scanner arranged on a downstream side of the recording portion 2300 in the conveyance direction. The inline scanner detects misregistration or a color density of the image formed on the sheet to allow correction of the printed image.

### (Drying Module)

The drying module 3000 includes a decoupling portion 3200, a drying belt unit 3300, and a hot-air blowing portion 3400. The drying module 3000 is a unit that reduces a liquid content in the inks that have been applied onto the sheet by the recording portion 2300 so as to increase fixability between the inks and the sheet. The sheet on which the ink image has been formed by the recording portion 2300 of the print module 2000 is conveyed to the decoupling portion 3200 arranged inside the drying module 3000. The decoupling portion 3200 applies a wind pressure from above so that the sheet is gently held on the belt, and conveys the sheet with a frictional force of the belt. In this manner, the sheet, on which the ink image is formed, on the print belt unit 2200 is prevented from being deviated. Hot air is blown from the hot-air blowing portion 3400 arranged above the drying belt unit 3300 onto the sheet that has been conveyed from the decoupling portion 3200 while the sheet is being attracted and conveyed by the drying belt unit 3300. In this manner, an ink-applied surface of the sheet is dried. A drying method may be, besides the method of blowing hot air, a method of irradiating a surface of a sheet with an electromagnetic wave (such as an ultraviolet ray or an infrared ray), a conduction heat transfer method using contact of a heating element, or a method using a combination of those methods.

### (Fixing Module)

The fixing module 4000 includes a fixing-belt unit 4100 and a first reversing portion 4200. The fixing-belt unit 4100 can fix the inks onto the sheet by causing the sheet conveyed from the drying module 3000 to pass between an upper belt unit and a lower belt unit that are heated. The first reversing portion 4200 is provided in a duplex-printing conveying portion of the fixing module 4000. The first reversing portion 4200 reverses the sheet.

### (Cooling Module)

The cooling module 5000 includes a plurality of cooling portions 5100 that cool the sheet having a high temperature, which has been conveyed from the fixing module 4000. Each of the cooling portions 5100 cools the sheet by taking an outside air into a cooling box with a fan to increase a pressure inside the cooling box and blowing a wind jetted out from nozzles formed in a conveyance guide onto the sheet. The cooling portions 5100 are arranged on both sides of the conveying path so as to cool the sheet from both sides.

Further, the cooling module 5000 includes a conveying-path switching portion 5200. The conveying-path switching portion 5200 switches the conveying path for the sheet depending on whether the sheet is conveyed to the reversing module 6000 or to a duplex-printing conveying path 1800 that is used at the time of duplex printing. At the time of duplex printing, the sheet is conveyed by the conveying-path switching portion 5200 to a conveying path 5300 in a lower portion of the cooling module 5000. The sheet is conveyed from the conveying path 5300 to the duplex-printing conveying path 1800 inside the feeding module 1000 via a conveying path 4300 inside the fixing module 4000, a conveying path 3500 inside the drying module 3000, and a conveying path 2400 inside the print module 2000. The sheet is conveyed from the duplex-printing conveying path 1800 to the before-image-formation registration correcting portion 2100, the print belt unit 2200, and the recording portion 2300 of the print module 2000 again, and an ink image is formed by the recording portion 2300.

### (Reversing Module)

The reversing module 6000 includes a second reversing portion 6400. The second reversing portion 6400 reverses a front side and a back side of the sheet being conveyed. Thus, the reversing module 6000 can switch the orientation between the front side and the back side of the sheet to be discharged.

### (Discharge Stacking Module)

The discharge stacking module 7000 includes a top tray 7200 and a stacking portion 7500. The discharge stacking module 7000 aligns the sheets conveyed from the reversing module 6000 and stacks the sheets on the top tray 7200 or the stacking portion 7500.

The image forming apparatus 1 according to the embodiment is an ink jet type recording apparatus (ink jet recording apparatus) that forms an ink image on a sheet as a recording medium. However, the image forming apparatus 1 is not limited to the ink jet type one. The image forming apparatus 1 may be, for example, an electrophotographic image forming apparatus that forms a toner image on a sheet as a recording medium.

### (Configuration of Feeding Module)

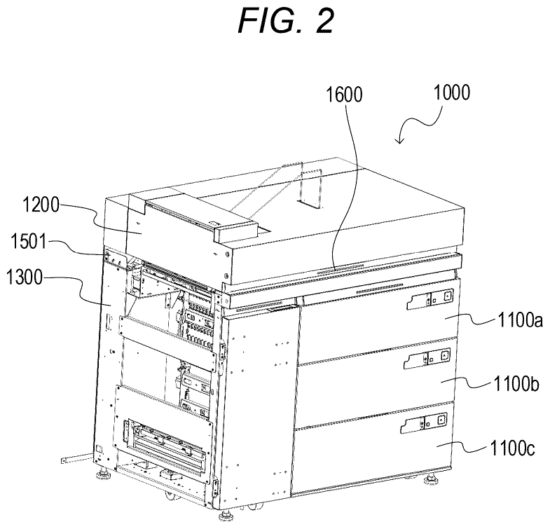

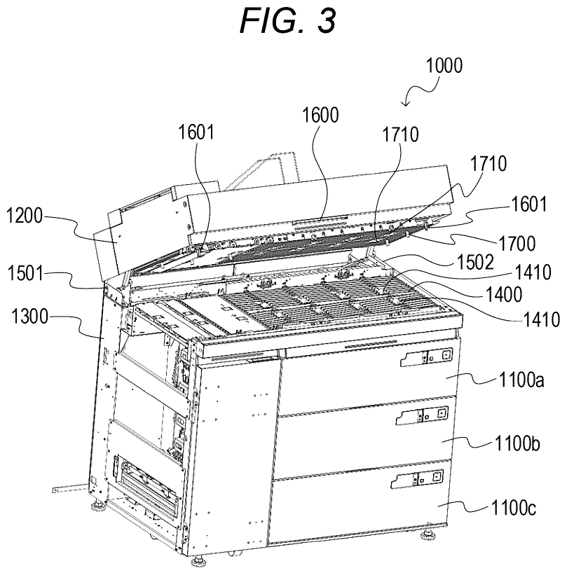

Next, a configuration of the feeding module 1000 is described with reference to FIG. 2 and FIG. 3. FIG. 2 is a schematic perspective view of the feeding module 1000. FIG. 3 is a schematic perspective view of the feeding module 1000 with an upper door unit open. As illustrated in FIG. 2, the feeding module 1000 includes the storages 1100a, 1100b, and 1100c that are stacked one on top of another in a vertical direction. An upper door unit (opening and closing door) 1200 is arranged above the storage 1100a. As illustrated in FIG. 3, the upper door unit 1200 is rotatably coupled to a housing 1300 of the feeding module 1000 through intermediation of a left hinge 1501 and a right hinge 1502, which are arranged on a left side and a right side on a back side of the upper door unit 1200.

An upper conveying unit 1700 is supported by the upper door unit 1200. The upper conveying unit 1700 includes a first conveying surface and conveying rollers (first conveying rollers) 1710. The first conveying surface forms a part of a conveying path for the sheets. The conveying rollers 1710 are rotatable. The conveying rollers 1710 are elastically urged with a predetermined pressing force in a direction toward the housing 1300. A lower conveying unit 1400 is supported by the housing 1300. The lower conveying unit 1400 includes a second conveying surface and conveying rollers (second conveying rollers) 1410. The second conveying surface forms the part of the conveying path for the sheets. The conveying rollers 1410 are rotatable. The conveying rollers 1410 are rotated by a driving force output from a drive source. When the upper door unit 1200 is in a closed state, the conveying rollers 1410 and the conveying rollers 1710 are brought into abutment against each other at a predetermined nip pressure to form roller pairs. The first conveying surface and the second conveying surface define the conveying path. When the conveying rollers 1410 are rotated by the driving force output from the drive source, the conveying rollers 1710 are rotationally driven in association with the rotation of the conveying rollers 1410. The sheet fed from the storage 1100a, 1100b, or 1100c is conveyed to the roller pairs (conveying rollers 1410 and 1710) and is conveyed to a downstream side by the roller pairs.

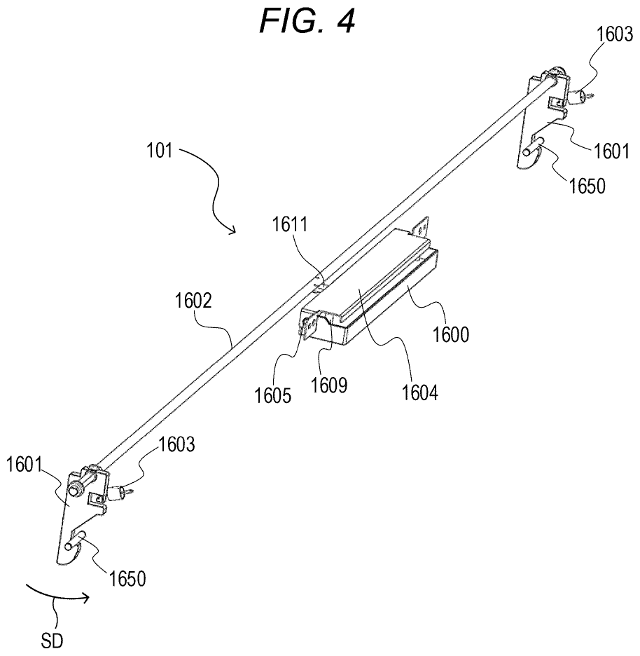

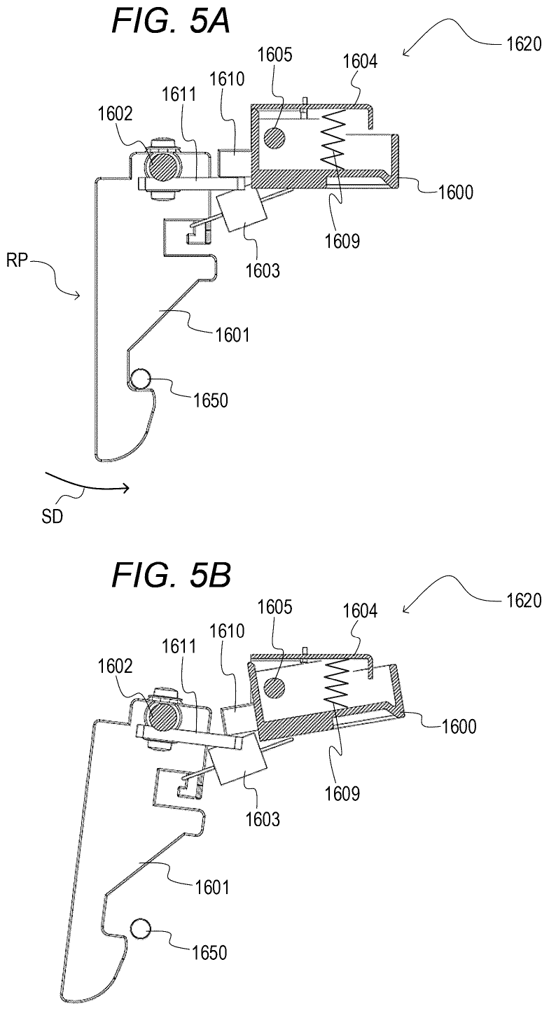

Next, a configuration of latches 1601 provided to the upper door unit 1200 and engaged members 1650 provided to the housing 1300 are described with reference to FIG. 4, FIG. 5A, and FIG. 5B. FIG. 4 is a schematic perspective view of a handle 1600, the latches 1601, and other components in the vicinity thereof. A latch apparatus 101 that locks the upper door unit 1200 to the housing 1300 includes the latches 1601, the engaged members 1650, and the handle 1600. FIG. 5A and FIG. 5B are schematic sectional views of a latch releasing mechanism 1620 of the handle 1600 and other components in the vicinity thereof. FIG. 5A is a view for illustrating a latch engaged state in which the latch 1601 is engaged with the engaged member 1650. FIG. 5B is a view for illustrating a latch released state after the latch 1601 is disengaged from the engaged member 1650.

When accessing an inside of the feeding module 1000 at the time of a paper jam clearing process or maintenance, a user operates the handle 1600 provided at a substantially central portion of a main body of the feeding module 1000. Then, the latch releasing mechanism 1620 acts to allow the upper door unit 1200 to be opened. The handle 1600 is rotatably supported by a rotation-shaft support plate 1604 through intermediation of a handle rotation shaft 1605. The handle 1600 is elastically urged by a handle urging spring 1609 so as to return to a predetermined initial position of the handle 1600.

Further, a rotation transmitting portion 1610 is provided on a back side of the handle 1600. The rotation transmitting portion 1610 is arranged so as to be in contact with a rotation transmitted portion 1611 provided to a latch shaft 1602. The latch shaft 1602 is rotatably supported at both end portions of the upper door unit 1200. The latches 1601 are fixed to both ends of the latch shaft 1602, respectively. The latches 1601 are rotated in association with rotating of the latch shaft 1602. Further, the latches 1601 are elastically urged by latch urging springs (second elastic members) 1603 in a second direction SD in which the latches 1601 are rotated toward the engaged members 1650. The latches 1601 are configured to be returned to return positions (predetermined positions) RP with predetermined return forces applied by the latch urging springs 1603 after a rotating operation of the latches 1601 is performed and then cancelled.

The engaged members 1650 are provided to the housing 1300 and are engageable with the latches 1601. The latches 1601 are configured to be disposed in positions in which the latches 1601 are engaged with the engaged members 1650 provided to the housing 1300 in a state in which the upper door unit 1200 is closed. The upper door unit 1200 can be maintained in a closed state by the engagement of the latches 1601 with the engaged members 1650. When the latches 1601 are operated by the handle 1600 in a state in which the upper door unit 1200 is closed, the latches 1601 can be disengaged from the engaged members 1650. For opening the upper door unit 1200, the user operates the handle 1600 upwards to rotate the handle 1600 about the handle rotation shaft 1605. The rotating of the handle 1600 causes the latch shaft 1602 and the latches 1601 to be rotated through intermediation of the rotation transmitting portion 1610 and the rotation transmitted portion 1611. As a result, the latches 1601 are disengaged from the engaged members 1650. Then, the upper door unit 1200 is allowed to be rotated about a rotation center of the left hinge 1501 and the right hinge 1502. As illustrated in FIG. 3, after the upper door unit 1200 is opened with respect to the housing 1300, maintenance work or paper jam clearing work can be performed on the upper conveying unit 1700 provided to the upper door unit 1200 or the lower conveying unit 1400 provided to the housing 1300.

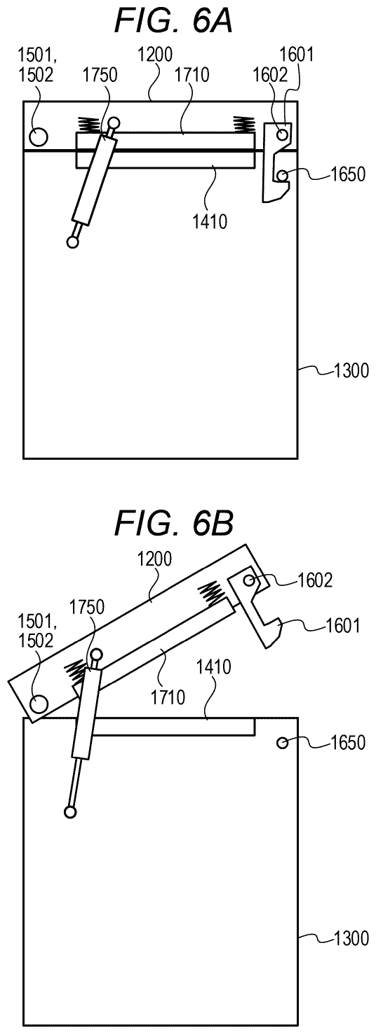

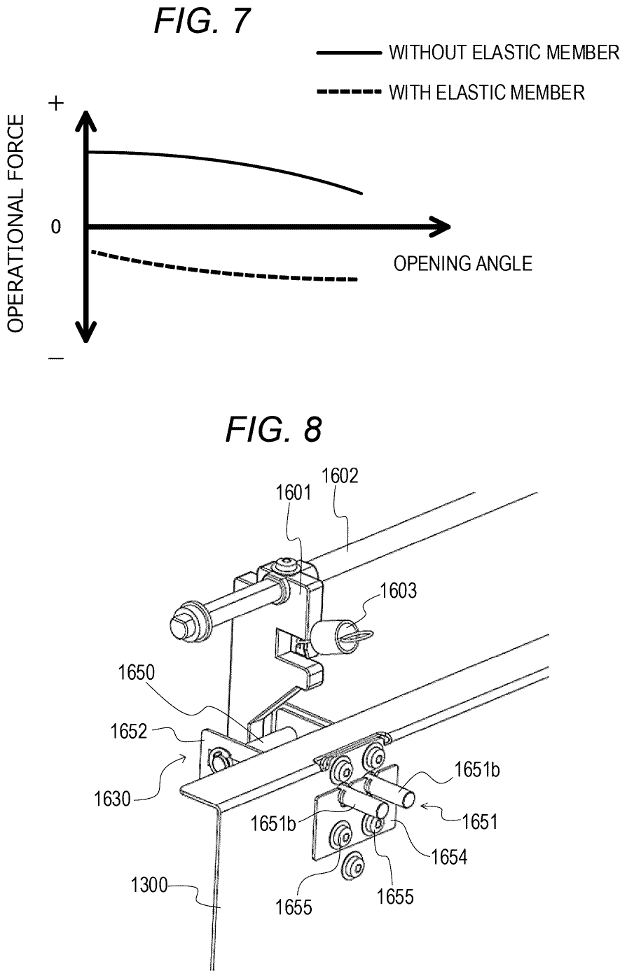

FIG. 6A and FIG. 6B are schematic side sectional views of the upper door unit 1200 provided with an elastic member 1750 for operation assistance. FIG. 7 is a graph for showing an example of operational force curves when the upper door unit 1200 is opened and closed. FIG. 6A is a view of the upper door unit 1200 in a closed state. FIG. 6B is a view of the upper door unit 1200 in an open state. Further, a vertical axis of FIG. 7 represents an operational force. The operational force that is required to open the upper door unit 1200 is indicated on a positive side of the vertical axis, and the operational force that is required to close the upper door unit 1200 is indicated on a negative side of the vertical axis. A horizontal axis of FIG. 7 represents an opening angle of the upper door unit 1200 with respect to the housing 1300. The upper door unit 1200 is more widely opened and the opening angle is increased from a left side of the horizontal axis toward its right side.

In the image forming apparatus 1 having a large size, the upper door unit 1200 that supports the upper conveying unit 1700 often has large weight. Thus, for example, a configuration in which the upper door unit 1200 is elastically urged by the elastic members 1750 such as gas springs in a direction of opening the upper door unit 1200 is used in some cases. With this configuration, the operational force required when the user opens the upper door unit 1200 is reduced to thereby improve operability. The arrangement and urging forces of the elastic members 1750 can be appropriately set. Operational behavior at the time of opening and closing the upper door unit 1200 is appropriately set. In view of the operability, it is preferred that, for example, the upper door unit 1200 be configured to be automatically opened by the elastic members 1750 as illustrated in FIG. 6B after the latches 1601 are disengaged from the engaged members 1650 through the operation of the handle 1600. In this case, the urging forces of the elastic members 1750, which are applied to the upper door unit 1200 in a state in which the upper door unit 1200 is closed, are received by the latches 1601 and the engaged members 1650. Further, the nip pressure applied by the roller pairs formed by the upper conveying unit 1700 and the lower conveying unit 1400 is also received by the latches 1601 and the engaged members 1650.

When the upper door unit 1200 is large and heavy as in the embodiment, relative positions of the latch 1601 and the engaged member 1650 may be shifted by, for example, warping of the upper door unit 1200, which is caused by a self-weight, or a dimensional variation of a component. With a shift in the relative positions of the latch 1601 and the engaged member 1650, the latches 1601 may be unsatisfactorily engaged or fail to be engaged with the engaged members 1650 and thus result in a nonengaged state.

In particular, in the embodiment, the conveying rollers 1710 of the upper conveying unit 1700 provided to the upper door unit 1200 are pressed against the conveying rollers 1410 of the lower conveying unit 1400 provided to the housing 1300 to form the roller pairs. When a sheet having high stiffness such as a sheet of thick paper is conveyed to the roller pairs, a reaction force generated when the sheet is interposed between the rollers of the roller pairs is received by the latches 1601 and the engaged members 1650. The reaction force acts in a direction of opening the upper door unit 1200, that is, a direction of releasing the latches 1601. Thus, the reaction force may further increase the warping of the upper door unit 1200 and cause the shift in the relative positions of the latch 1601 and the engaged member 1650.

When the upper door unit 1200 is closed in a state in which the relative positions of the latch 1601 and the engaged member 1650 are shifted, the upper door unit 1200 is not maintained in the closed position and undesirably opens again. Specifically, the upper door unit 1200 is in a so-called “door ajar state” in which the upper door unit 1200 cannot be maintained in a position in which the upper door unit 1200 should be. As a result, the roller pairs cannot have an appropriate pressing force (nip pressure). Thus, a problem such as infeasibility of an appropriate sheet conveying operation may occur.

It is conceivable to increase the amount of contact between the latches 1601 and the engaged member 1650 so as to prevent nonengagement. In such a case, however, the latches 1601 and the latch releasing mechanism 1620 including the rotation transmitted portion 1611 are enlarged, leading to enlargement of the feeding module 1000 as a whole. Further, it is also conceivable, for example, to adjust a position of the upper door unit 1200 through position adjustment of the left hinge 1501 and the right hinge 1502. However, the upper door unit 1200 of the feeding module 1000 having a large size is heavy. Thus, the position of the upper door unit 1200 is required to be adjusted by a plurality of workers or by using a tool such as a lifting apparatus. Accordingly, workability is lowered. Thus, in the embodiment, a position of the engaged member 1650 with respect to a position of the latch 1601 can be adjusted. As a result, the relative positions of the latches 1601 and the engaged member 1650 can be appropriately adjusted without enlarging the latches 1601 or the latch releasing mechanism 1620.

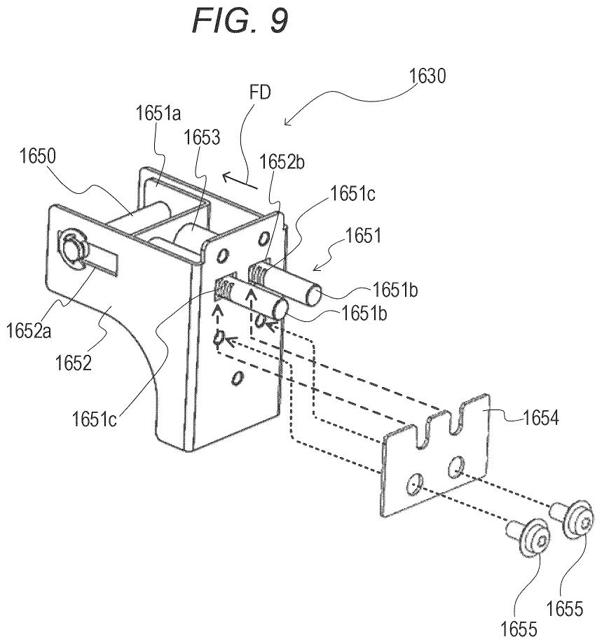

Next, a position adjusting portion 1630 for the engaged member 1650 is described with reference to FIG. 8 and FIG. 9. The position adjusting portion 1630 of the embodiment is an example, and a position adjusting portion is not limited to the position adjusting portion 1630 as long as the position of the engaged member 1650 can be adjusted by moving the engaged member 1650. FIG. 8 is a schematic perspective view of the latch 1601, the engaged member 1650, and other components in the vicinity thereof. FIG. 9 is a schematic perspective view of a support member 1651, the engaged member 1650, and other components in the vicinity thereof. As described above, the engaged member 1650, which is to be engaged with the latch 1601, is provided to the housing 1300. The engaged member 1650 is supported by the support member 1651. Further, both ends of the engaged member 1650 are supported by shaft-receiving portions 1652a of a fixed member 1652 so that the engaged member 1650 is movable in a direction (engagement direction) in which the amount of contact with the latch 1601 is increased and decreased.

In the embodiment, the support member 1651 is formed by coupling two shaft members 1651b to a base member 1651a. The fixed member 1652 is fixed to the housing 1300. The shaft members 1651b are arranged to extend through the fixed member 1652 and the housing 1300. Each of the shaft members 1651b is arranged so that at least a part of the shaft member 1651b is in contact with a corresponding one of penetration portions 1652b of the fixed member 1652. The shaft members 1651b and the engaged member 1650 are supported by the fixed member 1652 so as to be movable substantially parallel to the direction in which the amount of contact between the engaged member 1650 and the latch 1601 is increased and decreased. Further, the support member 1651 is elastically urged by elastic members (first elastic members) 1653 in a first direction FD in which the engaged member 1650 is moved toward the latch 1601. The engaged member 1650 is elastically urged through intermediation of the support member 1651 in the direction in which the amount of contact with the latch 1601 is increased.

A plurality of key grooves 1651c are formed on each of the shaft members 1651b extending through the housing 1300 so as to be arranged side by side in an axial direction of the shaft member 1651b. A stopper 1654 is engaged with the key grooves 1651c. The stopper 1654 is engaged with an appropriate one of the plurality of key grooves 1651c of each of the shaft members 1651b and is fixed to the housing 1300 with screws 1655. When the stopper 1654 is fixed to the housing 1300, the support member 1651 including the shaft members 1651b and the engaged member 1650 are positioned and are restricted from moving in the direction in which the amount of contact with the latch 1601 is increased or decreased. Specifically, the position of the engaged member 1650 can be changed by engaging the stopper 1654 with the key grooves 1651c at different positions. Meanwhile, a relationship between a pressing force (first urging force) F1 applied by the elastic members 1653 on the engaged member 1650 and a return force (second urging force) F2 applied by the latch urging spring 1603 on the latch 1601 is set so that the return force F2 is equal to or larger than the pressing force F1 (F1≤F2).

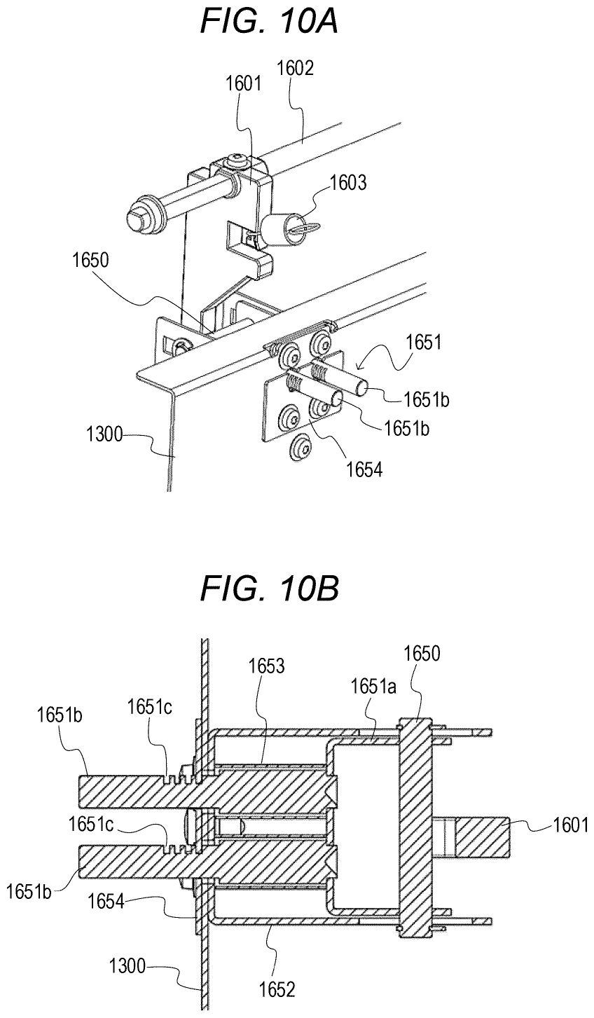

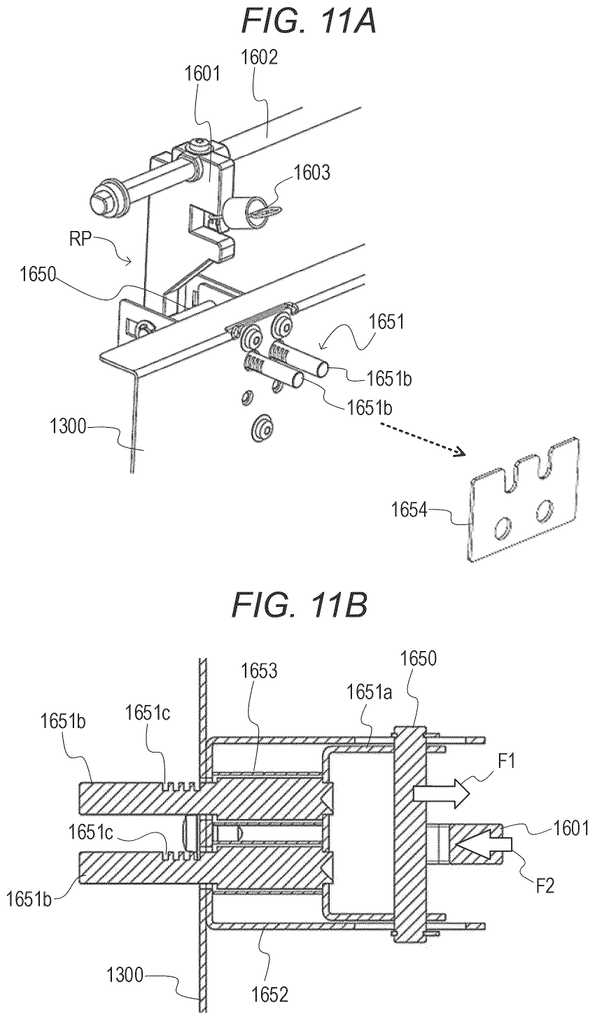

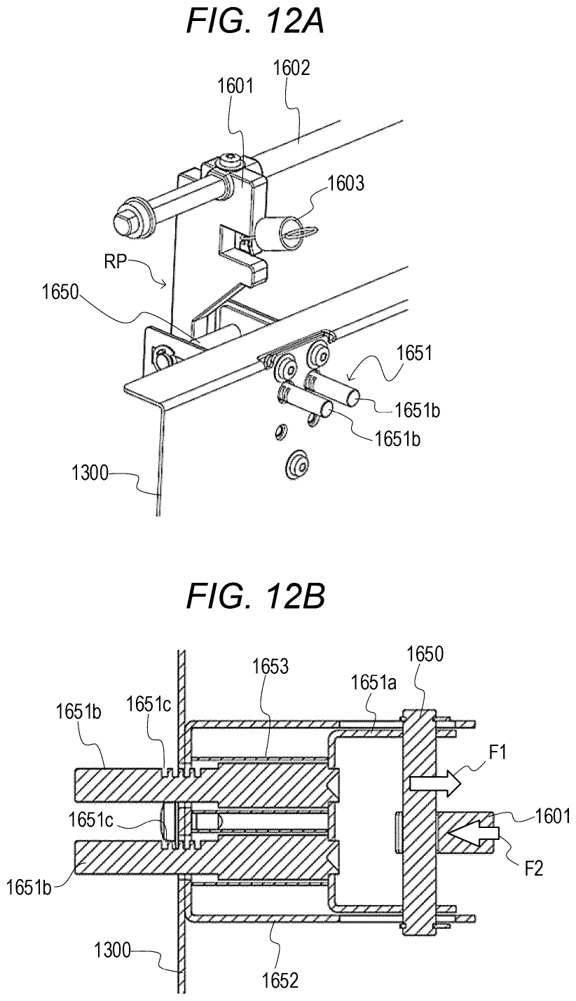

Next, a procedure of adjusting the position of the engaged member 1650 is described with reference to FIG. 10A, FIG. 10B, FIG. 11A, FIG. 11B, FIG. 12A, and FIG. 12B. FIG. 10A and FIG. 10B are schematic views for illustrating the engaged member 1650 before position adjustment. FIG. 11A and FIG. 11B are schematic views for illustrating the support member 1651 after the stopper 1654 is removed from the support member 1651 in the state illustrated in FIG. 10A and FIG. 10B. FIG. 12A and FIG. 12B are schematic views for illustrating the engaged member 1650 being in abutment against the latch 1601 after the engaged member 1650 is moved. FIG. 10A, FIG. 11A, and FIG. 12A are schematic perspective views. FIG. 10B, FIG. 11B, and FIG. 12B are schematic sectional views of the engaged member 1650 when viewed from above.

As illustrated in FIG. 10B, in the state before adjusting the position of the engaged member 1650, an engagement position of the stopper 1654 with the key grooves 1651c of the shaft members 1651 is set in advance so that the latch 1601 and the engaged member 1650 are in contact with each other by a small amount or are not in contact with each other. Then, as illustrated in FIG. 11A, the stopper 1654, which has been fixed to the housing 1300, is released in a state in which the upper door unit 1200 is closed. After that, the engaged member 1650 is moved by the urging forces of the elastic members 1653 in the direction in which the amount of contact with the latch 1601 is increased, and is then brought into abutment against the latch 1601. At this time, the relationship: F1≤F2 is set. Thus, as illustrated in FIG. 12A and FIG. 12B, when the engaged member 1650 is brought into abutment against the latch 1601 by the urging forces of the elastic members 1653, the latch 1601 is not moved and is held in the return position RP with the urging force of the latch urging spring 1603. The position of the engaged member 1650 can be adjusted to a position corresponding to the position of the latch 1601 by reengaging the stopper 1654 with the key grooves 1651c in a state in which the engaged member 1650 and the latch 1601 are in abutment against each other. The position of the engagement member 1650 can be adjusted in a state in which a direction in which the engaged member 1650 is moved bases a front.

According to the embodiment, even when the image forming apparatus 1 has a large size, accuracy in the relative positions of the engaged member 1650 and the latch 1601 is improved. Thus, the upper door unit 1200 is stably maintained in a closed state without enlarging the feeding module 1000. According to the embodiment, even when the image forming apparatus 1 has a large size, the relative positions of the engaged member 1650 and the latch 1601 can be appropriately adjusted without causing the enlargement of the feeding module 1000. Further, the adjusting method involves relatively simple work of removing the stopper 1654 in a state in which the upper door unit 1200 is closed and then mounting the stopper 1654 again. It is not required to visually check the position of the latch 1601 and the position of the engaged member 1650 each time the position of the engaged member 1650 is adjusted. Thus, workability is improved. Further, the adjustment method involves the use of the key grooves 1651c of the shaft members 1651b extending through the housing 1300 to allow the engagement position of the stopper 1654 to be selected. Thus, adjustment work is not required to be performed from the right or left side of the apparatus. Specifically, the position adjustment work for the engaged member 1650 is completed only through the work performed from a front side of the feeding module 1000 without decoupling the feeding module 1000 from an apparatus that is installed on an upstream or downstream side of the feeding module 1000 to form an image on a sheet. Thus, the workability is improved.

In the embodiment, the position adjusting portion 1630 that adjusts the position of the engaged member 1650 with respect to the position of the latch 1601 has been described for the feeding module 1000. However, a configuration of the position adjusting portion 1630 is not limited to that described above. The position adjusting portion 1630 is also applicable to, for example, an apparatus having a large opening and closing door, such as the fixing module 4000, the drying module 3000, or the reversing module 6000.

In the embodiment, the method using the plurality of key grooves 1651c formed on the shaft members 1651b and the stopper 1654 as the position adjusting portion 1630 that adjusts the position of the engaged member 1650 with respect to the position of the latch 1601 is employed so as to adjust the position of the engaged member 1650 in a stepwise manner. However, the position adjusting method is not limited to that described above. For example, a method of freely fixing the engagement position of the shaft members 1651b with use of, for example, snap rings may be used.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-138093, filed Aug. 28, 2023, which is hereby incorporated by reference herein in its entirety.

What is claimed is:

1. A latch apparatus configured to latch an opening and closing door that is opened and closed with respect to a housing to the housing, the latch apparatus comprising:
a latch to be provided to the opening and closing door;
a handle, which is to be provided to the opening and closing door and is configured to operate the latch; and
an engaged member, which is to be provided to the housing and is engageable with the latch,
wherein, when the opening and closing door is closed, the latch is engaged with the engaged member,
wherein, when the latch is operated by the handle in a state in which the opening and closing door is closed, the latch is disengageable from the engaged member, and
wherein a position of the engaged member is adjustable in an engagement direction in which the latch is brought into engagement with the engaged member.

2. The latch apparatus according to claim 1, further comprising a position adjusting portion configured to adjust the position of the engaged member with respect to the latch.

3. The latch apparatus according to claim 2, wherein the position adjusting portion includes a support member configured to support the engaged member so that the engaged member is movable in the engagement direction, and
wherein the support member is to be provided to the housing.

4. The latch apparatus according to claim 3, wherein a part of the support member extends through the housing, and
wherein, after the position of the engaged member is adjusted with respect to the latch, the support member is fixed to the housing.

5. The latch apparatus according to claim 1, wherein the engaged member is elastically urged by a first elastic member in a first direction toward the latch,
wherein the latch is elastically urged by a second elastic member in a second direction toward the engaged member, and
wherein a second urging force by which the second elastic member elastically urges the latch toward the engaged member is equal to or larger than a first urging force by which the first elastic member elastically urges the engaged member toward the latch.

6. The latch apparatus according to claim 1, wherein the position of the engaged member is adjustable in a state in which a direction in which the engaged member is moved faces a front.

7. The latch apparatus according to claim 1, wherein the opening and closing door is provided with a first conveying surface and a first conveying roller,
wherein the housing is provided with a second conveying surface and a second conveying roller, and
wherein, when the opening and closing door is closed, the first conveying surface and the second conveying surface form a conveying path through which a sheet is conveyed, and the first conveying roller and the second conveying roller are brought into abutment against each other with a predetermined pressing force to form a roller pair configured to convey the sheet through the conveying path.

8. A sheet conveying apparatus comprising:
a conveying portion configured to convey a sheet;
a housing;
an opening and closing door configured to be opened and closed with respect to the housing;
a latch provided to the opening and closing door;
a handle provided to the opening and closing door and configured to operate the latch; and
an engaged member, which is provided to the housing and is engageable with the latch,
wherein, when the opening and closing door is closed, the latch is engaged with the engaged member,
wherein, when the latch is operated by the handle in a state in which the opening and closing door is closed, the latch is disengageable from the engaged member, and
wherein a position of the engaged member is adjustable in an engagement direction in which the latch is brought into engagement with the engaged member.

9. The sheet conveying apparatus according to claim 8, further comprising a position adjusting portion configured to adjust the position of the engaged member with respect to the latch.

10. The sheet conveying apparatus according to claim 9, wherein the position adjusting portion includes a support member configured to support the engaged member so that the engaged member is movable in the engagement direction, and
wherein the support member is provided to the housing.

11. The sheet conveying apparatus according to claim 10, wherein a part of the support member extends through the housing, and
Wherein, after the position of the engaged member is adjusted with respect to the latch, the support member is fixed to the housing.

12. The sheet conveying apparatus according to claim 8, wherein the engaged member is elastically urged by a first elastic member in a first direction toward the latch,
wherein the latch is elastically urged by a second elastic member in a second direction toward the engaged member, and
wherein a second urging force by which the second elastic member elastically urges the latch toward the engaged member is equal to or larger than a first urging force by which the first elastic member elastically urges the engaged member toward the latch.

13. The sheet conveying apparatus according to claim 8, wherein the position of the engaged member is adjustable in a state in which a direction in which the engaged member is moved faces a front.

14. The sheet conveying apparatus according to claim 8, wherein the conveying portion includes a first conveying surface and a first conveying roller that are provided to the opening and closing door and a second conveying surface and a second conveying roller that are provided to the housing, and
wherein, when the opening and closing door is closed, the first conveying surface and the second conveying surface form a conveying path through which the sheet is conveyed, and the first conveying roller and the second conveying roller are brought into abutment against each other with a predetermined pressing force to form a roller pair configured to convey the sheet through the conveying path.

15. An image forming apparatus comprising:
a sheet conveying apparatus including
a conveying portion configured to convey a sheet,
a housing,
an opening and closing door configured to be opened and closed with respect to the housing,
a latch provided to the opening and closing door,
a handle provided to the opening and closing door and configured to operate the latch, and
an engaged member, which is provided to the housing and is engageable with the latch,
wherein, when the opening and closing door is closed, the latch is engaged with the engaged member,
wherein, when the latch is operated by the handle in a state in which the opening and closing door is closed, the latch is disengageable from the engaged member, and
wherein a position of the engaged member is adjustable in an engagement direction in which the latch is brought into engagement with the engaged member; and
an image forming portion configured to form an image on the sheet conveyed from the sheet conveying apparatus.
